(19) United States
(12) Patent Application Publication
(10) Pub. No.: US 2026/0226814 A1
(43) Pub. Date: Aug. 6, 2026

(54) SYSTEM AND METHOD FOR COUPLING GEOTHERMAL ENERGY STORAGE WITH COALBED METHANE EXTRACTION IN UNMINEABLE COALBED

(71) Applicant: CHINA UNIVERSITY OF GEOSCIENCES (WUHAN), Wuhan (CN)

(72) Inventors: Guohua ZHANG, Wuhan (CN); Chengyu LI, Wuhan (CN); Yanxin WANG, Wuhan (CN); Dongjie HUA, Wuhan (CN); Dawei HU, Wuhan (CN); Su JIANG, Wuhan (CN); Feng XIONG, Wuhan (CN); Fubin TU, Wuhan (CN); Fan HU, Wuhan (CN); Chong MA, Wuhan (CN)

(73) Assignee: CHINA UNIVERSITY OF GEOSCIENCES (WUHAN), Wuhan (CN)

(21) Appl. No.: 19/636,991

(22) Filed: Apr. 2, 2026

(30) Foreign Application Priority Data
Nov. 19, 2025 (CN) 202511704076.7

(51) Int. Cl. E21B 43/00; F03G 4/00

(52) U.S. Cl. CPC E21B 43/006; F03G 4/026; F03G 4/037

(57) ABSTRACT

A system for coupling geothermal energy storage with coalbed methane extraction in an unmineable coalbed includes a ground heat collection unit, a heat injection and energy storage unit, and a cogeneration unit. The ground heat collection unit is configured to collect and convert solar energy and surplus electricity from wind and photovoltaic power generation into high-temperature thermal energy. The heat injection and energy storage unit includes a heat injection device, an injection well, an extraction well, an artificial heat storage space, an upper covering stratum, and a lower covering stratum. The cogeneration unit is connected to the extraction well and configured to utilize the high-temperature thermal energy for heating/cooling and recycle the free coalbed methane for gas supply and power generation. In this way, unmineable coalbed resources are developed, and the solar energy and the surplus electricity from wind and photovoltaic power generation are absorbed.

### CROSS-REFERENCE TO RELATED APPLICATIONS

This application claims priority to Chinese Patent Application No. 202511704076.7 with a filing date of Nov. 19, 2025. The content of the aforementioned application, including any intervening amendments thereto, is incorporated herein by reference.

### TECHNICAL FIELD

The present disclosure relates to the technical field of new energy storage and resource development, and in particular, to a system and method for coupling geothermal energy storage with coalbed methane extraction in an unmineable coalbed.

### BACKGROUND

As fossil energy resources continue to deplete and environmental challenges increasingly intensify, the pursuit of the “dual carbon” goals has accelerated the development of new power systems centered on new energy sources such as geothermal energy, solar energy, wind energy, and ocean energy. However, the intermittent and unstable nature of solar energy and wind energy leads to high curtailment rates and significant waste of clean energy. This creates an urgent need for large-scale, long-duration energy storage technologies to absorb the surplus electricity.

Among various new energy sources, geothermal energy is regarded as one of the most promising alternatives to fossil fuel energy sources due to its stability, renewability, and higher capacity factor compared to other renewable energy sources. However, traditional geothermal development relies on naturally occurring high-grade hot dry rock strata or aquifers. Furthermore, due to the uneven distribution of resources, most medium-to-deep geothermal resources exhibit low utilization efficiency and stability as limited by reservoir temperatures and geothermal recovery cycles during the extraction process. Consequently, there is a lack of an efficient and stable solution.

To address the above problems, a feasible and promising solution involves leveraging geothermal resources present in formations. This entails converting energy such as solar energy and wind energy into storable thermal energy and injecting it into geothermal reservoirs to enhance the grade and density of the subsurface thermal energy. The application of geothermal energy storage is primarily constrained by the need to find suitable thermal reservoirs, which generally require favorable geotemperature and sealing conditions and well-developed fracture systems. Traditional geothermal extraction typically targets medium-to-deep geothermal fields. However, for geothermal energy storage, selecting medium-to-deep geothermal fields as thermal reservoirs involves high preliminary exploration costs and stringent site selection criteria. Additionally, reconstructing some hot dry rock strata can be expensive. In general, the economic efficiency is low, necessitating the search for more suitable reservoirs.

On the other hand, China possesses a vast amount of “unmineable coalbeds” where extraction is risky or uneconomical due to great burial depth and complex geological conditions. Although these deep gas-bearing unmineable coalbeds lack mining value, they often contain abundant adsorbed or free coalbed methane, representing abundant resources. Moreover, they possess numerous primary and secondary fractures, exhibiting favorable reservoir characteristics. Such unmineable coalbeds also have a certain inherent geotemperature, and thus can be considered as vast natural heat reservoirs. Currently, while the development of shallow mines is well-established, methods for the resource utilization of deep gas-bearing unmineable coalbeds are scarce. Economic development and utilization using traditional technologies can be challenging. In the prior art, solutions for utilizing underground spaces for energy storage mostly treat these spaces merely as energy storage reservoirs, and both energy utilization efficiency and economic benefits need to be improved. Therefore, to increase the economic benefits of deep gas-bearing unmineable coalbeds, innovative technological pathways that organically combine energy storage and resource exploitation can be considered.

### SUMMARY OF PRESENT INVENTION

A main objective of the present disclosure is to provide a system and method for coupling geothermal energy storage with coalbed methane extraction in an unmineable coalbed to solve the above problems.

To achieve the above objective, the present disclosure provides a system for coupling geothermal energy storage with coalbed methane extraction in an unmineable coalbed, including:
a ground heat collection unit configured to collect and convert solar energy and surplus electricity from wind and photovoltaic power generation into high-temperature thermal energy;
a heat injection and energy storage unit including a heat injection device, and an injection well, an extraction well, an artificial heat storage space, an upper covering stratum, and a lower covering stratum that are arranged in a formation, where the injection well and the extraction well are spaced apart along a horizontal direction of the formation, and each extend downward to and communicate with a deep gas-bearing unmineable coalbed within the formation; a part of the unmineable coalbed between the injection well and the extraction well is reconstructed to form the artificial heat storage space with a permeability of 10-100 mD; a tight rock stratum covering an upper side of the unmineable coalbed is the upper covering stratum, while a tight rock stratum covering a lower side of the unmineable coalbed is the lower covering stratum; the heat injection device is connected to the ground heat collection unit and the injection well, and is configured to inject, via the injection well, the high-temperature thermal energy obtained by the ground heat collection unit into the artificial heat storage space for storage and desorb adsorbed coalbed methane within the artificial heat storage space into free coalbed methane; and
a cogeneration unit connected to the extraction well and configured to extract and utilize, via the extraction well, the high-temperature thermal energy within the artificial heat storage space for heating/cooling and recycle the free coalbed methane for gas supply and power generation.

The present disclosure further provides a method for coupling geothermal energy storage with coalbed methane extraction in an unmineable coalbed, applied to the system for coupling geothermal energy storage with coalbed methane extraction in an unmineable coalbed and including the following steps:
selecting a deep gas-bearing unmineable coalbed within a formation, and determining an upper covering stratum and a lower covering stratum, where a tight rock stratum covering an upper side of the unmineable coalbed is the upper covering stratum, while a tight rock stratum covering a lower side of the unmineable coalbed is the lower covering stratum;
drilling an injection well and an extraction well, and reconstructing a part of the unmineable coalbed between the injection well and the extraction well to form an artificial heat storage space, where the artificial heat storage space has a permeability of 10-100 mD;
mounting a ground heat collection unit, a heat injection device, and a cogeneration unit, and connecting the heat injection device to the ground heat collection unit and the injection well and connecting the cogeneration unit to the extraction well; and
during daytime when sunlight is abundant or wind is strong, driving the ground heat collection unit and the heat injection device to enter a heat storage and energy injection phase; and during nighttime, during windless periods, when a power grid requires peak shaving, or during the heating/cooling seasons, driving the heat injection device and the cogeneration unit to enter a heat extraction and energy production phase.

In the technical solutions of the present disclosure, the abandoned unmineable coalbed is reconstructed into the artificial heat storage space, i.e., a vast “underground thermal battery”, and then the solar energy and the surplus electricity from wind and photovoltaic power generation are converted into thermal energy which is subsequently injected into the artificial heat storage space. Thus, the energy grade and the energy storage density can be significantly enhanced. This not only achieves geothermal energy storage but also promotes the desorption of the adsorbed coalbed methane into the free coalbed methane. When energy is needed, the stored thermal energy is extracted for heating/cooling, and during this process, coalbed methane resources are simultaneously recycled for gas supply or power generation, realizing “multi-purpose utilization of a single well” and comprehensive energy utilization. In this way, the resource development of the abandoned unmineable coalbed is enabled, achieving green and efficient recycling of abandoned resources in line with the circular economy concept. Furthermore, geothermal energy storage is combined with coalbed methane extraction, such that the solar energy and the surplus electricity from wind and photovoltaic power generation are effectively absorbed and utilized for stable thermal energy conversion and storage, as well as the output of high-value coalbed methane fuel. The cogeneration unit is integrated to achieve the poly-generation of efficient geothermal energy storage, stable power generation/heating/cooling, and synergistic coalbed methane extraction, offering advantages such as large-scale energy storage, long energy storage duration, high economic benefits, and low environmental pollution.

### BRIEF DESCRIPTION OF THE DRAWINGS

To explain the technical solutions in the embodiments of the present disclosure or in the prior art more clearly, the accompanying drawings required for describing the embodiments or the prior art will be described below briefly. Obviously, the accompanying drawings in the following description show merely some embodiments of the present disclosure, and other drawings can also be derived from structures illustrated in these accompanying drawings by a person of ordinary skill in the art without creative efforts.

FIG. 1 is a schematic structural diagram showing a system for coupling geothermal energy storage with coalbed methane extraction in an unmineable coalbed according to an embodiment of the present disclosure; and

FIG. 2 is a flowchart showing a method for coupling geothermal energy storage with coalbed methane extraction in an unmineable coalbed according to an embodiment of the present disclosure.

### List of Reference Numerals

100—System for coupling geothermal energy storage with coalbed methane extraction in unmineable coalbed
1—Injection well
2—Extraction well
3—Artificial heat storage space
4—Upper covering stratum
5—Lower covering stratum
6—Low-temperature medium storage tank
7—High-temperature medium storage tank
8—Solar collector array
9—Electric heating apparatus
10—Wind and photovoltaic power generation device
11—Circulating pump
12—First heat exchanger
13—Supercritical carbon dioxide Brayton cycle power generation device
14—Second heat exchanger
15—High-pressure injection pump
16—Third heat exchanger
17—Organic Rankine cycle power generation device
18—Extraction device
19—Gas-liquid separator
20—Heating/cooling device
21—Coalbed methane treatment and output device
22—Cooler
23—Reinjection pump

The implementation of the objective, functional characteristics and advantages of the present disclosure will be further described in conjunction with the examples and with reference to the accompanying drawings.

### DETAILED DESCRIPTION OF THE EMBODIMENTS

The following clearly and completely describes the technical solutions in the embodiments of the present disclosure with reference to the accompanying drawings in the embodiments of the present application. Apparently, the described embodiments are merely a part rather than all of the embodiments of the present application. All other embodiments derived from the embodiments of the present disclosure by a person of ordinary skill in the art without creative efforts shall fall within the protection scope of the present disclosure.

It should be noted that all the directional indications (such as upper, lower, left, right, front, and rear) in the embodiments of the present disclosure are used merely to explain relative position relationships, motion situations, or the like of components in specific gestures (as shown in the accompanying drawings). If the specific gestures change, the directional indications also change accordingly.

In addition, the terms such as “first”, “second”, or the like described in the embodiments of the present disclosure are used herein only for the purpose of description and are not intended to indicate or imply relative importance, or implicitly indicate the number of indicated technical features. Therefore, a feature limited by “first” or “second” may explicitly or implicitly include at least one such feature. In addition, the meaning of “and/or” used throughout the specification includes three solutions. With A and/or B as an example, it includes a technical solution A, a technical solution B, and a technical solution of A and B. Additionally, the technical solutions of the embodiments may be combined with each other on the basis that the combination is implementable by those of ordinary skill in the art. In case a combination of the technical solutions is contradictory or infeasible, such a combination is deemed inexistent and not falling within the protection scope of the present disclosure.

A feasible and promising solution involves leveraging geothermal resources present in formations. This entails converting energy such as solar energy and wind energy into storable thermal energy and injecting it into geothermal reservoirs to enhance the grade and density of the subsurface thermal energy. The application of geothermal energy storage is primarily constrained by the need to find suitable thermal reservoirs, which generally require favorable geotemperature and sealing conditions and well-developed fracture systems. Traditional geothermal extraction typically targets medium-to-deep geothermal fields. However, for geothermal energy storage, selecting medium-to-deep geothermal fields as thermal reservoirs involves high preliminary exploration costs and stringent site selection criteria. Additionally, reconstructing some hot dry rock strata can be expensive. In general, the economic efficiency is low, necessitating the search for more suitable reservoirs.

On the other hand, China possesses a vast amount of “unmineable coalbeds” where extraction is risky or uneconomical due to great burial depth and complex geological conditions. Although these deep gas-bearing unmineable coalbeds lack mining value, they often contain abundant adsorbed or free coalbed methane, representing abundant resources. Moreover, they possess numerous primary and secondary fractures, exhibiting favorable reservoir characteristics. Such unmineable coalbeds also have a certain inherent geotemperature, and thus can be considered as vast natural heat reservoirs. Currently, while the development of shallow mines is well-established, methods for the resource utilization of deep gas-bearing unmineable coalbeds are scarce. Economic development and utilization using traditional technologies can be challenging. In the prior art, solutions for utilizing underground spaces for energy storage mostly treat these spaces merely as energy storage reservoirs, and both energy utilization efficiency and economic benefits need to be improved. Therefore, to increase the economic benefits of deep gas-bearing unmineable coalbeds, innovative technological pathways that organically combine energy storage and resource exploitation can be considered.

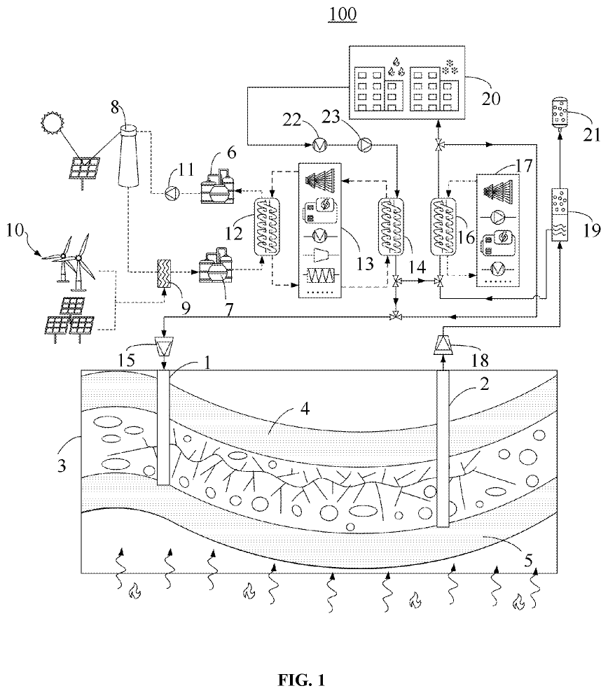

In view of the above, the present disclosure provides a system 100 for coupling geothermal energy storage with coalbed methane extraction in an unmineable coalbed. FIG. 1 illustrates an embodiment of the system 100 for coupling geothermal energy storage with coalbed methane extraction in an unmineable coalbed provided by the present disclosure.

Referring to FIG. 1, the system 100 for coupling geothermal energy storage with coalbed methane extraction in an unmineable coalbed includes a ground heat collection unit, a heat injection and energy storage unit, and a cogeneration unit. The ground heat collection unit is configured to collect and convert solar energy and surplus electricity from wind and photovoltaic power generation into high-temperature thermal energy. The heat injection and energy storage unit includes a heat injection device, and an injection well 1, an extraction well 2, an artificial heat storage space 3, an upper covering stratum 4, and a lower covering stratum 5 that are arranged in a formation. The injection well 1 and the extraction well 2 are spaced apart along a horizontal direction of the formation, and each extend downward to and communicate with a deep gas-bearing unmineable coalbed within the formation. A part of the unmineable coalbed between the injection well 1 and the extraction well 2 is reconstructed to form the artificial heat storage space 3 with a permeability of 10-100 mD. A tight rock stratum covering an upper side of the unmineable coalbed is the upper covering stratum 4, while a tight rock stratum covering a lower side of the unmineable coalbed is the lower covering stratum 5. The heat injection device is connected to the ground heat collection unit and the injection well 1, and is configured to inject, via the injection well 1, the high-temperature thermal energy obtained by the ground heat collection unit into the artificial heat storage space 3 for storage and desorb adsorbed coalbed methane within the artificial heat storage space 3 into free coalbed methane. The cogeneration unit is connected to the extraction well 2 and configured to extract and utilize, via the extraction well 2, the high-temperature thermal energy within the artificial heat storage space 3 for heating/cooling and recycle the free coalbed methane for gas supply and power generation.

In the technical solutions of the present disclosure, the abandoned unmineable coalbed is reconstructed into the artificial heat storage space 3, i.e., a vast “underground thermal battery”, and then the solar energy and the surplus electricity from wind and photovoltaic power generation are converted into thermal energy which is subsequently injected into the artificial heat storage space 3. Thus, the energy grade and the energy storage density can be significantly enhanced. This not only achieves geothermal energy storage but also promotes the desorption of the adsorbed coalbed methane into the free coalbed methane. When energy is needed, the stored thermal energy is extracted for heating/cooling, and during this process, coalbed methane resources are simultaneously recycled for gas supply or power generation, realizing “multi-purpose utilization of a single well” and comprehensive energy utilization. In this way, the resource development of the abandoned unmineable coalbed is enabled, achieving green and efficient recycling of abandoned resources in line with the circular economy concept. Furthermore, geothermal energy storage is combined with coalbed methane extraction, such that the solar energy and the surplus electricity from wind and photovoltaic power generation are effectively absorbed and utilized for stable thermal energy conversion and storage, as well as the output of high-value coalbed methane fuel. The cogeneration unit is integrated to achieve the poly-generation of efficient geothermal energy storage, stable power generation/heating/cooling, and synergistic coalbed methane extraction, offering advantages such as large-scale energy storage, long energy storage duration, high economic benefits, and low environmental pollution.

It should be noted that, in the present disclosure, the deep gas-bearing unmineable coalbed is buried at a depth of 1000-3000 meters within the formation, and has a thickness of 5-20 meters, an internal total gas content of more than 8-25 m³/t, a free gas proportion of more than 20%, a gas saturation of greater than 40%, and a critical desorption pressure to reservoir pressure ratio of 0.2-0.6. The unmineable coalbed itself develops natural fractures and primary pores in the coal matrix (with a porosity of greater than 2-8%), and has a certain initial permeability (0.05-3.0 mD) and an initial geotemperature (60-120° C.). The roof and floor of the unmineable coalbed consist of dense mudstone, shale, or siltstone (with a permeability of less than 0.01 mD, a porosity of less than 5%, and a thickness of 10-30 meters), forming excellent natural covering strata, designated as the upper covering stratum 4 and the lower covering stratum 5. These covering strata possess good sealing properties, effectively preventing vertical leakage of heat and fluids and thereby significantly reducing the uncertainty and high exploration costs associated with traditional geothermal reservoir exploration.

Moreover, in the present disclosure, the part of the unmineable coalbed between the injection well 1 and the extraction well 2 is reconstructed by using a hydraulic fracturing technique or a chemical technique to form the artificial heat storage space 3, which is an inter-well (200-800 meters) multi-scale heat exchange zone with a high permeability (10-100 mD) and a large specific surface area. The artificial heat storage space 3 includes not only the primary pores and secondary fractures of the coal and rock mass but also the fracture network created by fracturing. Its purpose is to provide sufficient contact area and flow channels during thermal energy injection, thereby enabling efficient heat exchange between the coal mass and the thermal energy. Thus, the injected heat is effectively stored in the target horizon, with a heat loss rate significantly lower than that of surface facilities. Accordingly, long-term energy storage is achieved.

It should also be noted that, in the present disclosure, the heat storage and gas production process of the heat injection and energy storage unit is as follows: when a high-temperature heat-carrying working medium is injected into the fracture network of the coal and rock mass, it continuously transfers heat to the coal and rock mass. The heating of the coal matrix causes coalbed methane to desorb. Therefore, the process of heat storage within the coal and rock mass as a vast solid heat storage medium is simultaneously the production process of increased coalbed methane. Thus, this transforms the deep gas-bearing unmineable coalbed from a low-grade natural heat source into an efficient “underground thermal battery” capable of actively storing and releasing energy while synergistically producing high-value coalbed methane. As a result, an upgrade from a waste resource to a poly-generation energy system is achieved.

Further, referring to FIG. 1, the ground heat collection unit includes a low-temperature medium storage tank 6, a high-temperature medium storage tank 7, a solar collector array 8, an electric heating apparatus 9, a wind and photovoltaic power generation device 10, a circulating pump 11, and a first heat exchanger 12, forming a closed-loop heat-collecting working medium circulation circuit.

The solar collector array 8 includes a plurality of solar collectors distributed in an array on the ground. An inlet of the solar collector array 8 is connected to an outlet of the low-temperature medium storage tank 6 for heating a low-temperature heat-collecting working medium flowing out of the low-temperature medium storage tank 6. More specifically, in an embodiment of the present disclosure, the low-temperature heat-collecting working medium within the low-temperature medium storage tank 6 is molten salt.

The wind and photovoltaic power generation device 10 is arranged on the ground and electrically connected to a power supply end of the electric heating apparatus 9 such that the surplus electricity from wind and photovoltaic power generation by the wind and photovoltaic power generation device 10 drives the electric heating apparatus 9 to work. In other words, a heating end of the electric heating apparatus 9 is connected to the low-temperature medium storage tank 6 for heating the low-temperature heat-collecting working medium with the surplus electricity from wind and photovoltaic power generation. More specifically, the power input end of the electric heating apparatus 9 is connected to a specific node of the power grid via a dedicated power transmission line or switching station so as to preferentially absorb the surplus electricity from wind and photovoltaic power generation that is restricted from outputting by power grid dispatching instructions. The surplus electricity from wind and photovoltaic power generation is electricity that is dispatched and restricted from outputting when the instantaneous generated power of the wind and photovoltaic power generation device 10 exceeds the absorption capability of the power grid. The wind and photovoltaic power generation device 10 includes a first wind generating set and a photovoltaic power generation array that are connected to the power grid and configured to generate electricity. The first wind generating set is composed of a plurality of first horizontal-axis wind generators. The generated voltage is boosted by a box-type transformer before being collected into a wind farm step-up substation. The photovoltaic power generation array is composed of crystalline silicon photovoltaic modules that are connected in series and parallel to form a photovoltaic array. The generated direct current is converted to alternating current by a string inverter or a centralized inverter, and the alternating current is collected into a photovoltaic power station step-up substation. The electricity from the wind farm step-up substation and the photovoltaic power station step-up substation is ultimately collected to a specific node for integration into the regional power grid. The electric heating apparatus 9 is an electric heater, an electric heating tube, or the like.

It should be noted that, in the present disclosure, the low-temperature heat-collecting working medium can be heated by the solar collector array 8, by the electric heating apparatus 9, or jointly by both the solar collector array 8 and the electric heating apparatus 9. The specific heating method is selected based on actual conditions, namely the actual amount of solar energy collected and the quantity of surplus electricity from wind and photovoltaic power generation.

The outlet of the low-temperature medium storage tank 6 is connected to an inlet of the high-temperature medium storage tank 7 such that a high-temperature heat-collecting working medium formed by heating the low-temperature heat-collecting working medium to a preset temperature flows into the high-temperature medium storage tank 7. The high-temperature thermal energy is generated by the high-temperature heat-collecting working medium. More specifically, the low-temperature heat-collecting working medium is heated to a temperature of 550-700° C. to form the high-temperature heat-collecting working medium that flows into the high-temperature medium storage tank 7.

An outlet of the high-temperature medium storage tank 7 is connected to a hot-side inlet of the first heat exchanger 12 such that the high-temperature heat-collecting working medium within the high-temperature medium storage tank 7 flows into the first heat exchanger 12 and exchanges heat with a supercritical carbon dioxide power-generation working medium within the first heat exchanger 12.

A hot-side outlet of the first heat exchanger 12 is connected to an inlet of the low-temperature medium storage tank 6 such that the low-temperature heat-collecting working medium formed after heat exchange of the high-temperature heat-collecting working medium flowing into the first heat exchanger 12 flows back into the low-temperature medium storage tank 6, thereby achieving circulation of the heat-collecting working medium.

The circulating pump 11 is arranged between the low-temperature medium storage tank 6 and the solar collector array 8. Based on the lower viscosity of the low-temperature working medium, positioning the circulating pump 11 in this manner can reduce the requirements for the pump and the damage to the pump.

In the ground heat collection unit, the circulating pump 11 drives the heat-collecting working medium to circulate continuously throughout the entire circuit. The low-temperature medium storage tank 6 and the high-temperature medium storage tank 7 provide a stable source of working medium and buffer space for the entire circuit.

Further, referring to FIG. 1, the heat injection device includes a supercritical carbon dioxide Brayton cycle power generation device 13, a second heat exchanger 14, and a high-pressure injection pump 15, achieving energy utilization and resource recovery.

The supercritical carbon dioxide Brayton cycle power generation device 13 is connected to a cold-side outlet of the first heat exchanger 12 and configured to output high-grade electricity after doing work via the heated supercritical carbon dioxide power-generation working medium flowing from the first heat exchanger 12.

A hot-side inlet of the second heat exchanger 14 is connected to an exhaust end of the supercritical carbon dioxide Brayton cycle power generation device 13 such that a heat-carrying working medium within the second heat exchanger 14 exchanges heat with the supercritical carbon dioxide power-generation working medium cooled by doing work and discharged from the exhaust end of the supercritical carbon dioxide Brayton cycle power generation device 13, thereby generating a high-temperature and high-pressure heat-carrying working medium. A hot-side outlet of the second heat exchanger 14 is connected to a cold-side inlet of the first heat exchanger 12, allowing the supercritical carbon dioxide power-generation working medium after exchanging heat with the heat-carrying working medium within the second heat exchanger 14 to flow back into the first heat exchanger 12. More specifically, in an embodiment of the present disclosure, the heat-collecting working medium within the second heat exchanger 14 is water.

The high-pressure injection pump 15 has an inlet connected to a first cold-side outlet of the second heat exchanger 14 and an outlet connected to the injection well 1 such that the high-temperature and high-pressure heat-carrying working medium is injected into the artificial heat storage space 3 sequentially through the high-pressure injection pump 15 and the injection well 1.

As such, during daytime when sunlight is abundant or wind is strong, the ground heat collection unit and the heat injection device enter a heat storage and energy injection phase. The supercritical carbon dioxide working medium heated in the first heat exchanger 12 enters the supercritical carbon dioxide Brayton cycle power generation device 13 to do work, thereby driving the supercritical carbon dioxide Brayton cycle power generation device 13 to output high-grade electricity. This process exhibits high power generation efficiency and is the first stage for achieving efficient thermal energy utilization. After power generation, the supercritical carbon dioxide working medium is cooled to a temperature of 200-350° C., and then enters the second heat exchanger 14. In the second heat exchanger 14, the supercritical carbon dioxide working medium exchanges heat with the heat-carrying working medium (water) within the second heat exchanger 14, generating high-temperature and high-pressure water/steam (150-300° C.). The supercritical carbon dioxide working medium is treated before flowing back to the second heat exchanger 14. Thus, a cycle is completed.

Further, the supercritical carbon dioxide Brayton cycle power generation device 13 includes a first turbine, a compressor, a precooler, and a first generator. A working medium inlet of the first turbine is connected to the cold-side outlet of the first heat exchanger 12, and an output shaft of the first turbine is connected to an input shaft of the first generator, thereby driving, with the thermal energy of the heated supercritical carbon dioxide power-generation working medium flowing from the first heat exchanger 12, the first generator to generate power. A working medium outlet of the first turbine is formed at the exhaust end of the supercritical carbon dioxide Brayton cycle power generation device 13 and configured for connection with the hot-side inlet of the second heat exchanger 14 such that the supercritical carbon dioxide power-generation working medium cooled by doing work flows into the second heat exchanger 14 and exchanges heat with the heat-carrying working medium within the second heat exchanger 14. An inlet of the precooler is connected to the hot-side outlet of the second heat exchanger 14 such that the supercritical carbon dioxide power-generation working medium after exchanging heat with the heat-carrying working medium within the second heat exchanger 14 is cooled by the precooler. An outlet of the precooler is connected to a working medium inlet of the compressor such that the cooled supercritical carbon dioxide power-generation working medium flows into the compressor for compression. A working medium outlet of the compressor is connected to the cold-side inlet of the first heat exchanger 12 such that the cooled and compressed supercritical carbon dioxide power-generation working medium flows back into the first heat exchanger 12. In this way, a complete supercritical carbon dioxide Brayton cycle loop is formed.

Specifically, referring to FIG. 1, a second cold-side outlet of the second heat exchanger 14 is connected to a hot-side inlet of a third heat exchanger 16 such that a heat-carrying working medium within the third heat exchanger 16 exchanges heat with the high-temperature and high-pressure heat-carrying working medium to generate a high-temperature heat-carrying working medium. A cold-side outlet of the third heat exchanger 16 is connected to an organic Rankine cycle power generation device 17 such that the organic Rankine cycle power generation device 17 outputs electricity after doing work via the high-temperature heat-carrying working medium. A first hot-side outlet of the third heat exchanger 16 is connected to the high-pressure injection pump 15 such that the high-temperature heat-carrying working medium within the third heat exchanger 16 or the high-temperature heat-carrying working medium after doing work flows into the artificial heat storage space through the high-pressure injection pump 15. A second hot-side outlet of the third heat exchanger 16 is connected to the cogeneration unit such that the high-temperature heat-carrying working medium within the third heat exchanger 16 or the high-temperature heat-carrying working medium after doing work provides heating/cooling through the cogeneration unit.

As such, during daytime when sunlight is abundant or wind is strong, the ground heat collection unit and the heat injection device enter the heat storage and energy injection phase. If the power grid currently needs power, high-temperature and high-pressure water/steam generated through heat exchange between the heat-carrying working medium within the second heat exchanger 14 and the supercritical carbon dioxide working medium preferentially flows through the third heat exchanger 16 and exchanges heat with the power-generation working medium in the organic Rankine cycle power generation device 17 to generate power.

If the high-temperature and high-pressure water/steam is injected at a relatively high temperature, its temperature and pressure decrease after power generation, but it may still carry high-grade waste heat (above 150° C.). In this case, the high-grade waste heat can similarly be directed to the injection well 1 for storage in the artificial heat storage space. If, after power generation, the heat-carrying working medium only retains low-grade thermal energy (below 80° C.), it can be used directly for heating/cooling. If there is a relative surplus of thermal energy and energy storage is the primary objective, most or all of the high-temperature and high-pressure water/steam (150-300° C.) generated can be directed straight to the injection well 1.

Additionally, the high-temperature and high-pressure heat-carrying working medium coming directly from the second heat exchanger 14, after being utilized by the organic Rankine cycle power generation device 17, becomes residual heat-carrying working medium. This working medium is pressurized to the target pressure by the high-pressure injection pump 15 and then injected into the artificial heat storage space 3 via the injection well 1. Once the residual heat-carrying working medium is injected into the fracture network, it continuously transfers heat to the cooler coal matrix through forced convective heat exchange during its flow process. The coal and rock mass continually stores this heat within its enormous heat capacity, its temperature gradually rising from the initial formation temperature (150-250° C.). This causes the adsorbed coalbed methane in the micropores of the coal matrix to desorb and become free gas, achieving the synergistic storage of thermal energy and coalbed methane. After several weeks or months of continuous injection, a vast “thermal battery” is established in the reservoir.

It should be noted that, in an embodiment of the present disclosure, the cold-side outlet of the second heat exchanger 14 is split into two branches via a three-way control valve: one branch is a first cold-side outlet formed at one outlet of the three-way valve and configured for connection to the injection well 1 via the high-pressure injection pump 15; and the other branch is a second cold-side outlet formed at the other outlet of the three-way valve and configured for connection to the third heat exchanger 16.

It should also be noted that, in an embodiment of the present disclosure, the first hot-side inlet and the first hot-side outlet of the third heat exchanger 16 are integrated onto the three-way control valve.

Further, the organic Rankine cycle power generation device 17 includes a second turbine, a working medium pump, a condenser, and a second generator. A working medium inlet of the second turbine is connected to the cold-side outlet of the third heat exchanger 16, and an output shaft of the second turbine is connected to an input shaft of the second generator, thereby driving, with the high-temperature heat-carrying working medium flowing from the third heat exchanger 16, the second generator to generate power. A working medium outlet of the second turbine is connected to a working medium inlet of the condenser. A working medium outlet of the condenser is connected to an inlet of the working medium pump. An outlet of the working medium pump is connected to the cold-side inlet of the third heat exchanger 16. In this way, a complete organic Rankine cycle loop is formed.

Specifically, referring to FIG. 1, the cogeneration unit includes an extraction device 18, a gas-liquid separator 19, a heating/cooling device 20, a coalbed methane treatment and output device 21, and a natural gas pipeline network/power grid. An extraction end of the extraction device 18 is connected to the extraction well 2 and configured to extract a gas-liquid mixture of high-temperature and high-pressure heat-carrying working medium and coalbed methane within the artificial heat storage space 3 via the extraction well 2. The gas-liquid separator 19 is connected to the extraction device 18 and configured to separate the gas-liquid mixture delivered from the extraction device 18 into a liquid phase and a gas phase. The heating/cooling device 20 is connected to a liquid phase outlet of the gas-liquid separator 19 and configured to utilize the liquid phase delivered from the gas-liquid separator 19 for heating/cooling. The coalbed methane treatment and output device 21 is connected to a gas phase outlet of the gas-liquid separator 19 and configured to treat the gas phase. The natural gas pipeline network/power grid is connected to the gas-liquid separator 19 and configured to utilize the treated gas phase delivered from the coalbed methane treatment and output device 21 for gas/power supply.

During periods of energy demand, such as nighttime, during windless periods, when the power grid requires peak shaving, or during the heating season, the heat injection device and the cogeneration unit enter the heat extraction and energy production phase, and the extraction well 2 is activated. Under the action of reservoir pressure and gas expansion, the gas-liquid mixture stored in the underground thermal reservoir, namely the high-temperature fluid (120-250° C.), and the desorbed free coalbed methane may be extracted via the extraction device 18. The gas-liquid mixture first enters the gas-liquid separator 19 for separation. The separated high-temperature and high-pressure working medium (i.e., the liquid phase) enters the heating/cooling device 20 to provide heating or cooling for regional users. Alternatively, it may first enter the organic Rankine cycle power generation device 17 for power generation, after which the spent steam or hot water from power generation then enters the heating/cooling device 20. Moreover, the separated coalbed methane (i.e., the gas phase) enters the coalbed methane treatment and output device 21 for treatment (including dehydration, desulfurization, pressurization, etc.). After being treated to meet standards, it enters the natural gas pipeline network/power grid for gas/power supply.

In the system 100 for coupling geothermal energy storage with coalbed methane extraction in an unmineable coalbed provided by the present disclosure, by integrating the supercritical carbon dioxide Brayton cycle power generation and the organic Rankine cycle power generation, it is possible to improve the efficiency of new energy power generation, smooth out the fluctuations of new energy generation, enhance power grid stability, and achieve the poly-generation of efficient geothermal energy storage, stable power generation and heating/cooling, and synergistic coalbed methane extraction.

Further, referring to FIG. 1, the cogeneration unit further includes a cooler 22 and a reinjection pump 23. The cooler 22 has an input end connected to the heating/cooling device 20 and the natural gas pipeline network/power grid and is configured to cool the liquid phase that has been utilized by the heating/cooling device 20 and the gas phase that has been utilized by the natural gas pipeline network/power grid. The reinjection pump 23 is connected to an output end of the cooler 22 and a cold-side inlet of the second heat exchanger 14 so as to deliver the liquid phase and the gas phase cooled by the cooler 22 into the second heat exchanger 14 as the heat-carrying working medium.

Thus, the high-temperature and high-pressure fluid (i.e., liquid phase) and coalbed methane (i.e., gas phase) obtained after separation by the gas-liquid separator 19, after utilization, form a low-temperature fluid. This low-temperature fluid is cooled by the cooler 22 to a temperature close to the ambient temperature. The cooled fluid is pressurized by the reinjection pump 23 and delivered to the second heat exchanger 14 to serve as the heat-carrying working medium, awaiting reheating in the next energy storage cycle by the thermal energy of the supercritical carbon dioxide power-generation working medium.

Specifically, the extraction device 18 includes a Christmas tree and a manual lifting apparatus. The Christmas tree is connected to the extraction well 2 to eject the gas-liquid mixture within the artificial heat storage space. The manual lifting apparatus is connected to the Christmas tree.

As such, under the action of reservoir pressure and gas expansion, the gas-liquid mixture stored in the underground thermal reservoir, namely the high-temperature fluid (120-250° C.), and the desorbed free coalbed methane can be extracted through natural flow via the Christmas tree. However, when the wellhead pressure of the extraction well 2 is insufficient to overcome the frictional force in the wellbore and the gravitational force, i.e., when natural flow capacity is inadequate, the mixture can be extracted using the manual lifting apparatus.

More specifically, the manual lifting apparatus is a gas lift device or a high-temperature electric submersible pump.

In the system 100 for coupling geothermal energy storage with coalbed methane extraction in an unmineable coalbed provided by the present disclosure, a complete “energy storage-gas production-power generation-heating/cooling” cycle can be accomplished. This enables the value-added utilization of abandoned coalbeds, while simultaneously achieving the poly-generation of efficient geothermal energy storage, stable power generation and heating/cooling, and synergistic coalbed methane extraction.

In the system 100 for coupling geothermal energy storage with coalbed methane extraction in an unmineable coalbed provided by the present disclosure, flexible switching between two modes can be performed based on power grid load, weather conditions, and heating/electricity/gas demands. This enables “charging” and “discharging” of the underground thermal reservoir, maximizing both the economic and environmental benefits of the system.

In the system 100 for coupling geothermal energy storage with coalbed methane extraction in an unmineable coalbed provided by the present disclosure, when coalbed methane resources are nearly depleted, supercritical carbon dioxide can be selected as the underground heat-carrying working medium to achieve higher system efficiency and carbon sequestration benefits.

In the system 100 for coupling geothermal energy storage with coalbed methane extraction in an unmineable coalbed provided by the present disclosure, a plurality of deep gas-bearing unmineable coalbeds distributed within conventional and tight reservoir strata in a region can be simultaneously developed and utilized. This enables the integrated, large-scale development of coalbed resources in the region that are otherwise difficult to exploit economically, thereby reducing drilling costs per unit of energy storage and ground facility investment. The high-temperature heat-carrying working medium can be distributed to different injection wells 1 for injection into the thermal reservoirs of coalbeds, with its injection flow rate and pressure adjusted according to the heat storage capacity and requirements of each bed, thereby achieving uniform heat storage. During the heat extraction and energy production phase, based on production demands and the temperature and pressure of the fluids produced from the coalbeds, the extraction well 2 with the highest temperature and pressure is preferentially activated to ensure power generation efficiency.

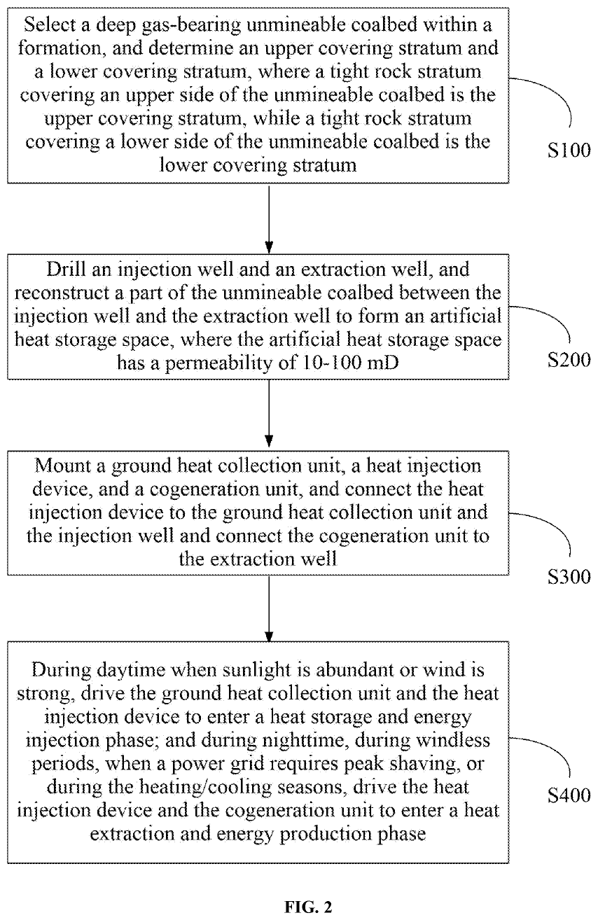

The present disclosure further provides a method for coupling geothermal energy storage with coalbed methane extraction in an unmineable coalbed, applied to the system for coupling geothermal energy storage with coalbed methane extraction in an unmineable coalbed described above. Referring to FIG. 2, the method includes the following steps.

In step S100, a deep gas-bearing unmineable coalbed within a formation is selected, and an upper covering stratum and a lower covering stratum are determined, where a tight rock stratum covering an upper side of the unmineable coalbed is the upper covering stratum, while a tight rock stratum covering a lower side of the unmineable coalbed is the lower covering stratum.

Specifically, in an embodiment of the present disclosure, the unmineable coalbed is buried at a depth of 1500 meters, and has a thickness of 10 meters and an initial geotemperature of approximately 60° C. The coal rock mass has generated hydrocarbons, with organic matter enriched and of moderate maturity. It does not possess economic value for coal mining but contains abundant adsorbed coalbed methane. The coalbed has an internal total gas content of 15 m³/t, a free gas proportion of 40%, a gas saturation of 80%, and a critical desorption pressure to reservoir pressure ratio of greater than 0.5. The unmineable coalbed itself develops natural fractures and primary pores in the coal matrix, and has a porosity of 6% and a permeability of 1 mD. Both the upper covering stratum and the lower covering stratum consist of dense mudstone, shale, or siltstone (with a permeability of 10⁻³ mD, a porosity of 2%, and a thickness of 20 meters).

In step S200, an injection well and an extraction well are drilled, and a part of the unmineable coalbed between the injection well and the extraction well is reconstructed to form an artificial heat storage space, where the artificial heat storage space has a permeability of 10-100 mD.

Specifically, in an embodiment of the present disclosure, the well spacing between the injection well and the extraction well is approximately 500 meters. A hydraulic fracturing technique is applied to reconstruct the part of the unmineable coalbed between the injection well and the extraction well, forming a multi-scale, high-surface-area, and highly interconnected fracture network (with a permeability of 40 mD). This ensures effective fluid flow paths and constructs an efficiently utilized artificial heat storage space.

In step S300, a ground heat collection unit, a heat injection device, and a cogeneration unit are mounted, and the heat injection device is connected to the ground heat collection unit and the injection well, and the cogeneration unit is connected to the extraction well.

In step S400, during daytime when sunlight is abundant or wind is strong, the ground heat collection unit and the heat injection device are driven to enter a heat storage and energy injection phase; and during nighttime, during windless periods, when a power grid requires peak shaving, or during the heating/cooling seasons, the heat injection device and the cogeneration unit are driven to enter a heat extraction and energy production phase.

The foregoing are merely preferred embodiments of the present disclosure, and the scope of the present disclosure is not limited thereto. Any equivalent structure change made using the content of the specification of the present disclosure and the drawings under the inventive concept of the present disclosure, or direct/indirect application thereof in other related technical fields, shall fall within the protection scope of the present disclosure.

What is claimed is:

1. A system for coupling geothermal energy storage with coalbed methane extraction in an unmineable coalbed, comprising:
a ground heat collection unit configured to collect and convert solar energy and surplus electricity from wind and photovoltaic power generation into high-temperature thermal energy;
a heat injection and energy storage unit comprising a heat injection device, and an injection well, an extraction well, an artificial heat storage space, an upper covering stratum, and a lower covering stratum that are arranged in a formation, wherein the injection well and the extraction well are spaced apart along a horizontal direction of the formation, and each extend downward to and communicate with a deep gas-bearing unmineable coalbed within the formation; a part of the unmineable coalbed between the injection well and the extraction well is reconstructed to form the artificial heat storage space with a permeability of 10-100 mD; a tight rock stratum covering an upper side of the unmineable coalbed is the upper covering stratum, while a tight rock stratum covering a lower side of the unmineable coalbed is the lower covering stratum; the heat injection device is connected to the ground heat collection unit and the injection well, and is configured to inject, via the injection well, the high-temperature thermal energy obtained by the ground heat collection unit into the artificial heat storage space for storage and desorb adsorbed coalbed methane within the artificial heat storage space into free coalbed methane; and
a cogeneration unit connected to the extraction well and configured to extract and utilize, via the extraction well, the high-temperature thermal energy within the artificial heat storage space for heating or cooling and recycle the free coalbed methane for gas supply and power generation.

2. The system according to claim 1, wherein the ground heat collection unit comprises a low-temperature medium storage tank, a high-temperature medium storage tank, a solar collector array, an electric heating apparatus, a wind and photovoltaic power generation device, a circulating pump, and a first heat exchanger;
the solar collector array comprises a plurality of solar collectors distributed in an array on the ground; an inlet of the solar collector array is connected to an outlet of the low-temperature medium storage tank for heating a low-temperature heat-collecting working medium flowing out of the low-temperature medium storage tank;
the wind and photovoltaic power generation device is arranged on the ground and electrically connected to a power supply end of the electric heating apparatus such that the surplus electricity from wind and photovoltaic power generation by the wind and photovoltaic power generation device drives the electric heating apparatus to work;
a heating end of the electric heating apparatus is connected to the low-temperature medium storage tank for heating the low-temperature heat-collecting working medium with the surplus electricity from wind and photovoltaic power generation;
the outlet of the low-temperature medium storage tank is connected to an inlet of the high-temperature medium storage tank such that a high-temperature heat-collecting working medium formed by heating the low-temperature heat-collecting working medium to a preset temperature flows into the high-temperature medium storage tank; the high-temperature thermal energy is generated by the high-temperature heat-collecting working medium;
an outlet of the high-temperature medium storage tank is connected to a hot-side inlet of the first heat exchanger such that the high-temperature heat-collecting working medium within the high-temperature medium storage tank flows into the first heat exchanger and exchanges heat with a supercritical carbon dioxide power-generation working medium within the first heat exchanger;
a hot-side outlet of the first heat exchanger is connected to an inlet of the low-temperature medium storage tank such that the low-temperature heat-collecting working medium formed after heat exchange of the high-temperature heat-collecting working medium flowing into the first heat exchanger flows back into the low-temperature medium storage tank; and
the circulating pump is arranged between the low-temperature medium storage tank and the solar collector array.

3. The system according to claim 2, wherein the heat injection device comprises:
a supercritical carbon dioxide Brayton cycle power generation device connected to a cold-side outlet of the first heat exchanger and configured to output high-grade electricity after doing work via the heated supercritical carbon dioxide power-generation working medium flowing from the first heat exchanger;
a second heat exchanger having a hot-side inlet and a hot-side outlet, wherein the hot-side inlet is connected to an exhaust end of the supercritical carbon dioxide Brayton cycle power generation device such that a heat-carrying working medium within the second heat exchanger exchanges heat with the supercritical carbon dioxide power-generation working medium cooled by doing work and discharged from the exhaust end of the supercritical carbon dioxide Brayton cycle power generation device, thereby generating a high-temperature and high-pressure heat-carrying working medium; and the hot-side outlet is connected to a cold-side inlet of the first heat exchanger, allowing the supercritical carbon dioxide power-generation working medium after exchanging heat with the heat-carrying working medium within the second heat exchanger to flow back into the first heat exchanger; and
a high-pressure injection pump having an inlet connected to a first cold-side outlet of the second heat exchanger and an outlet connected to the injection well such that the high-temperature and high-pressure heat-carrying working medium is injected into the artificial heat storage space sequentially through the high-pressure injection pump and the injection well.

4. The system according to claim 3, wherein the supercritical carbon dioxide Brayton cycle power generation device comprises a first turbine, a compressor, a precooler, and a first generator;
a working medium inlet of the first turbine is connected to the cold-side outlet of the first heat exchanger, and an output shaft of the first turbine is connected to an input shaft of the first generator, thereby driving, with the thermal energy of the heated supercritical carbon dioxide power-generation working medium flowing from the first heat exchanger, the first generator to generate power;
a working medium outlet of the first turbine is formed at the exhaust end of the supercritical carbon dioxide Brayton cycle power generation device and configured for connection with the hot-side inlet of the second heat exchanger such that the supercritical carbon dioxide power-generation working medium cooled by doing work flows into the second heat exchanger and exchanges heat with the heat-carrying working medium within the second heat exchanger;
an inlet of the precooler is connected to the hot-side outlet of the second heat exchanger such that the supercritical carbon dioxide power-generation working medium after exchanging heat with the heat-carrying working medium within the second heat exchanger is cooled by the precooler;
an outlet of the precooler is connected to a working medium inlet of the compressor such that the cooled supercritical carbon dioxide power-generation working medium flows into the compressor for compression; and
a working medium outlet of the compressor is connected to the cold-side inlet of the first heat exchanger such that the cooled and compressed supercritical carbon dioxide power-generation working medium flows back into the first heat exchanger.

5. The system according to claim 3, wherein a second cold-side outlet of the second heat exchanger is connected to a hot-side inlet of a third heat exchanger such that a heat-carrying working medium within the third heat exchanger exchanges heat with the high-temperature and high-pressure heat-carrying working medium to generate a high-temperature heat-carrying working medium;
a cold-side outlet of the third heat exchanger is connected to an organic Rankine cycle power generation device such that the organic Rankine cycle power generation device outputs electricity after doing work via the high-temperature heat-carrying working medium; a first hot-side outlet of the third heat exchanger is connected to the high-pressure injection pump such that the high-temperature heat-carrying working medium within the third heat exchanger or the high-temperature heat-carrying working medium after doing work flows into the artificial heat storage space through the high-pressure injection pump; and a second hot-side outlet of the third heat exchanger is connected to the cogeneration unit such that the high-temperature heat-carrying working medium within the third heat exchanger or the high-temperature heat-carrying working medium after doing work provides heating/cooling through the cogeneration unit.

6. The system according to claim 1, wherein the cogeneration unit comprises:
an extraction device having an extraction end connected to the extraction well and configured to extract a gas-liquid mixture of high-temperature and high-pressure heat-carrying working medium and coalbed methane within the artificial heat storage space via the extraction well;
a gas-liquid separator connected to the extraction device and configured to separate the gas-liquid mixture delivered from the extraction device into a liquid phase and a gas phase;
a heating/cooling device connected to a liquid phase outlet of the gas-liquid separator and configured to utilize the liquid phase delivered from the gas-liquid separator for heating or cooling;
a coalbed methane treatment and output device connected to a gas phase outlet of the gas-liquid separator and configured to treat the gas phase; and
a natural gas pipeline network/power grid connected to the gas-liquid separator and configured to utilize the treated gas phase delivered from the coalbed methane treatment and output device for gas/power supply.

7. The system according to claim 6, wherein the cogeneration unit further comprises:
a cooler having an input end connected to the heating/cooling device and the natural gas pipeline network/power grid and configured to cool the liquid phase that has been utilized by the heating or cooling device and the gas phase that has been utilized by the natural gas pipeline network/power grid; and
a reinjection pump connected to an output end of the cooler and a cold-side inlet of the second heat exchanger so as to deliver the liquid phase and the gas phase cooled by the cooler into the second heat exchanger as the heat-carrying working medium.

8. The system according to claim 6, wherein the extraction device comprises:
a Christmas tree connected to the extraction well to eject the gas-liquid mixture within the artificial heat storage space; and
a manual lifting apparatus connected to the Christmas tree.

9. The system according to claim 1, wherein the part of the unmineable coalbed between the injection well and the extraction well is reconstructed by using a hydraulic fracturing technique or a chemical technique to form the artificial heat storage space.

10. A method for coupling geothermal energy storage with coalbed methane extraction in an unmineable coalbed, applied to the system according to claim 1 and comprising following steps:
selecting a deep gas-bearing unmineable coalbed within a formation, and determining an upper covering stratum and a lower covering stratum, wherein a tight rock stratum covering an upper side of the unmineable coalbed is the upper covering stratum, while a tight rock stratum covering a lower side of the unmineable coalbed is the lower covering stratum;
drilling an injection well and an extraction well, and reconstructing a part of the unmineable coalbed between the injection well and the extraction well to form an artificial heat storage space, wherein the artificial heat storage space has a permeability of 10-100 mD;
mounting a ground heat collection unit, a heat injection device, and a cogeneration unit, and connecting the heat injection device to the ground heat collection unit and the injection well and connecting the cogeneration unit to the extraction well; and
during daytime when sunlight is abundant or wind is strong, driving the ground heat collection unit and the heat injection device to enter a heat storage and energy injection phase; and during nighttime, during windless periods, when a power grid requires peak shaving, or during heating/cooling seasons, driving the heat injection device and the cogeneration unit to enter a heat extraction and energy production phase.
